(19) United States
(12) Patent Application Publication
(10) Pub. No.: US 2004/0237614 A1
(43) Pub. Date: Dec. 2, 2004

(54) Lock cylinder with key

(76) Inventors: Norman Ketzler, Ratingen (DE); Peter Braun, Bornheim (DE); Peter Wollweber, Wesseling (DE)

Correspondence Address: THE BLACK & DECKER CORPORATION, 701 EAST JOPPA ROAD, TOWSON, MD, 21286, US

(21) Appl. No.: 10/852,322

(22) Filed: May 24, 2004

(30) Foreign Application Priority Data
May 28, 2003 (DE) 103 24 205.8

(51) Int. Cl. E05B 19/06; E05B 27/04

(52) U.S. Cl. 70/493; 70/409

(57) ABSTRACT

A lock cylinder (1) with a suitable key (2) is described, the lock cylinder (1) comprising a cylinder core (13) rotatably mounted in the cylinder housing (1′) and having a key channel (12) for entry of the key (2), which key (2) has a height-profiled rib (15) topping its broad side, of which the tumbler wards (29) cooperate with the tips of tumbler pins (18a) arranged in a row and consisting of non-rotatable core pins and housing pins in such a way that the tumbler pins (18a) guided in the core/housing apertures crossing the rotary joint (F) between cylinder core (13) and cylinder housing (1′) are aligned in terms of height such that the parting line (T) between core and housing pins (19, 20) aligns with the rotary joint (F). The rib (15) comprises a plurality of control tracks extending side by side in the key insertion direction, which as a consequence of an adapted tumbler pin tip configuration are selectively scanned by individual tumbler pins (18a).

The invention relates to a lock cylinder with a suitable key, the lock cylinder comprising a cylinder core rotatably mounted in the cylinder housing and having a key channel for entry of the key, which key has a height-profiled rib topping its broad side, of which the profile notches cooperate with the tips of tumbler pins arranged in a row and consisting of non-rotatable core pins and housing pins in such a way that the tumbler pins guided in the core/housing apertures crossing the rotary joint between cylinder core and cylinder housing are aligned in terms of height such that the parting line between core and housing pins aligns with the rotary joint.

A lock cylinder with key of the type in question is known from DE 31 36 314 C2, the tumbler pins arranged in rows one behind the other and cooperating with the rib being identical in their construction. The rib has a continuous groove into which core pin-side profiled ribs engage on insertion of the key.

The object of the invention is to configure a lock cylinder with key of the type in question such that an increased profile variation may be achieved in addition to increased locking security.

This object is firstly and substantially achieved in a lock cylinder with the features of claim 1, wherein this is geared toward the fact that the rib comprises a plurality of control tracks extending side by side in the key insertion direction and which as a consequence of an adapted tumbler pin tip configuration are selectively scanned by individual tumbler pins.

The subjects of the further claims are described hereinafter with reference to the subject of claim 1 but can also be significant in their independent wording.

As a consequence of such a configuration, a lock cylinder with key of the type in question is created whereby increased locking security can be achieved. An increased locking variation may also be achieved. In contrast to the prior art more than one control track extending side by side in the key insertion direction are accordingly provided on the rib, which tracks demand appropriately configured tumbler pins in the lock cylinder. The control tracks do not all have to have the same height level, rather differences may also prevail here, and this leads to an increase in the locking variation. There is only proper aligning of the tumbler pins when all tumbler pins are aligned above the control tracks such that the parting line between the core pins and housing pins is at the level of the rotary joint of the cylinder core. An anomaly at just one tumbler pin leads to rotational blocking of the cylinder core. The increased locking security also results from the fact that the further tumbler pins located behind the first tumbler pin, which cooperate with the rib, are arranged in a concealed position such that their nature cannot be discerned. An advantageous development consists, according to the invention, in that the tip of a tumbler pin scanning the one control track, in particular the control track outside the ribs, comprises a recess associated with the other control track, in particular the control track inside the ribs. This means that there is dependence between the tip and the control tracks. If, for example, there is no recess or it is too small, proper aligning of the relevant tumbler pin is not possible. In detail the procedure is such that the tip of a tumbler pin comprises a control bevel with control ridge associated with the control track scanned by it. The control bevel is used to allow a longitudinal displacement of the tumbler pin, caused by the control track, while the control ridge determines the final positioning of the tumbler pin. The nature of the tumbler pin may also be selected such that the control ridge of a tumbler pin scanning the control track inside the ribs is topped by a tip portion associated with the control track outside the ribs and with which a recess of the control track outside the ribs is associated. If this recess is missing, for example, proper allocation of the associated tumbler pin is not possible. So locking can be achieved with an improperly configured key or rib, the tip portion located next to the control bevel associated with the control track inside the ribs does not form control bevels, but in particular a step. To be able to displace the tumbler pin comprising the step by the relevant control bevel with a proper inserted key, the recess is longer than the tumbler pin diameter. Therefore, at the start of a key removal movement, displacement of the tumbler pin forming the step can already be initiated, whereby the step cannot assume a locking position. To increase the locking security a further row of tumbler pins is then provided which scan the notch-like wards of the key front and are staggered in the key insertion direction and are located, in particular, so as to overlap with the tumbler pins scanning the rib. This further row of tumbler pins primarily extends in the lock cylinder longitudinal centre plane as in the fundamental configuration of lock cylinders. Offsetting of the further row of tumbler pins with respect to the tumbler pins scanning the rib serves to minimise weakening of the cylinder housing. To achieve non-rotatability using simple means, the tumbler pins scanning the rib have a drop-shaped cross-section with drop tips located on the central longitudinal plane of the row of tumbler pins. In order to be independent of the drop-shape with respect to the configuration of the tips of the tumbler pins, the portion of the tumbler pin forming the tip is circular in cross-section. The flat key for the lock cylinder is distinguished in that the rib comprises at least two control tracks located side by side in the key insertion direction and which can be scanned by tumbler pins of the lock cylinder arranged parallel to one another and displaceable parallel to the broad side plane. This means that the tumbler pins scanning the rib extend in a row and parallel to the broad side plane of the key, which in turn forms at least two control tracks extending parallel to one another in the key insertion direction. Control tracks and shape of the tips of the tumbler pins have a dependent relationship here. To achieve long tumbler pins, the rib is adjacent to the key back. This means that the length of the core pins of these tumbler pins scanning the rib is greater than the length of the core pins touching the key front. Accordingly, profiled wards associated with the key front are located in front of the rib. It is also provided that the control track outside the ribs comprises at least one interruption point. This is used, when the key is inserted, to initiate a displacement of the tumbler pin associated with the interruption point in the initial displacement of the key removal movement. To be able to provide disruption-free insertion of the key into the key channel, the rib has two approach bevels offset in the key insertion direction, which are each associated with a control track. If there is no offset, the tumbler pin forming the step in the tip region prevents complete insertion of the key. In detail the procedure is such that the approach bevel outside the ribs is more remote from the key tip than the other approach bevel. This other approach bevel accordingly initiates displacement of the tumbler pin forming the step.

An embodiment of the invention will be described hereinafter with reference to the drawings, in which:

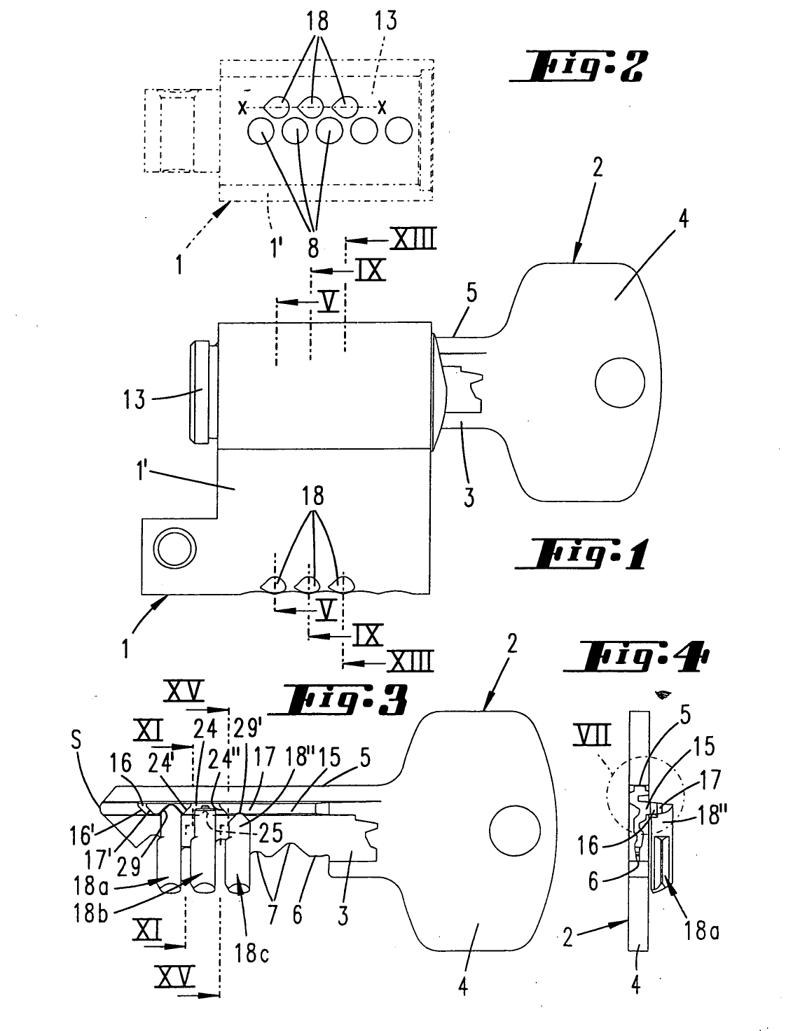

FIG. 1 shows a view of a lock cylinder configured according to the invention with inserted key,

FIG. 2 shows the view along arrow direction II in FIG. 1, the lock cylinder being shown in dot-dash lines and the two rows of tumbler pins in plan view,

FIG. 3 shows in detail the flat key with a view of the rib scanning the tumbler pins with properly aligned tumbler pins,

FIG. 4 shows the compressed view of FIG. 3,

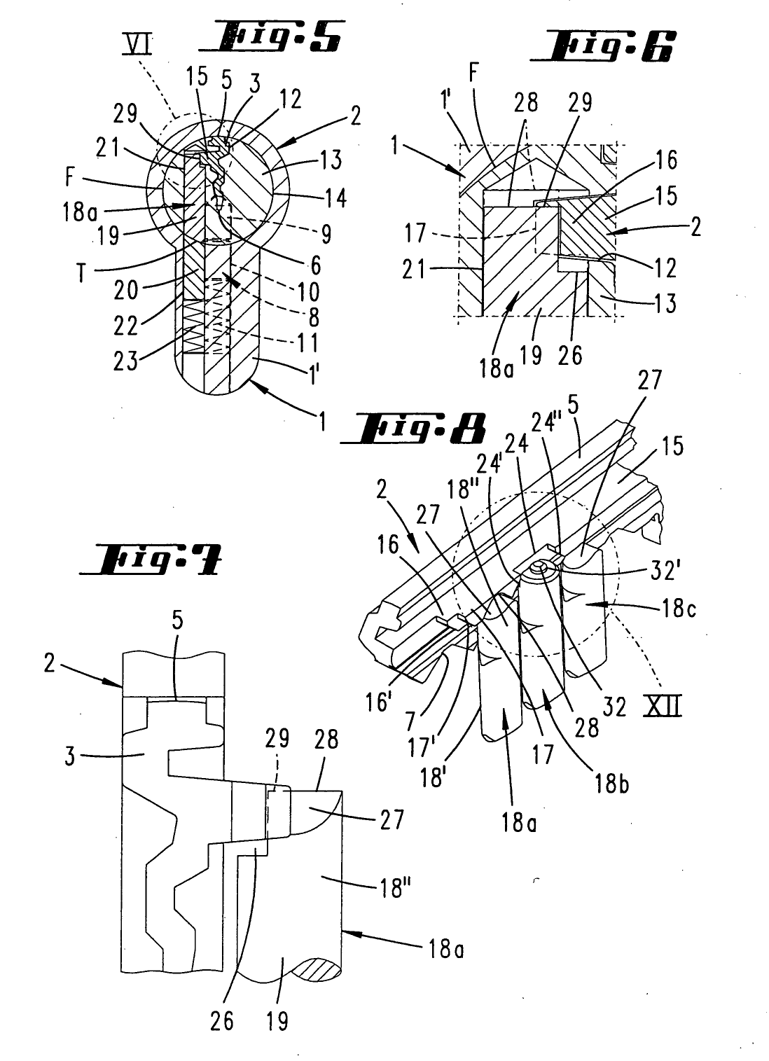

FIG. 5 shows the section along line V-V in FIG. 1,

FIG. 6 shows in a greatly enlarged view the detail according to VI in FIG. 5,

FIG. 7 is the detail according to VII in FIG. 4, greatly enlarged,

FIG. 8 is a perspective view of the key shank with tumbler pins controlled by the rib,

FIG. 9 shows the section along the line IX-IX in FIG. 1,

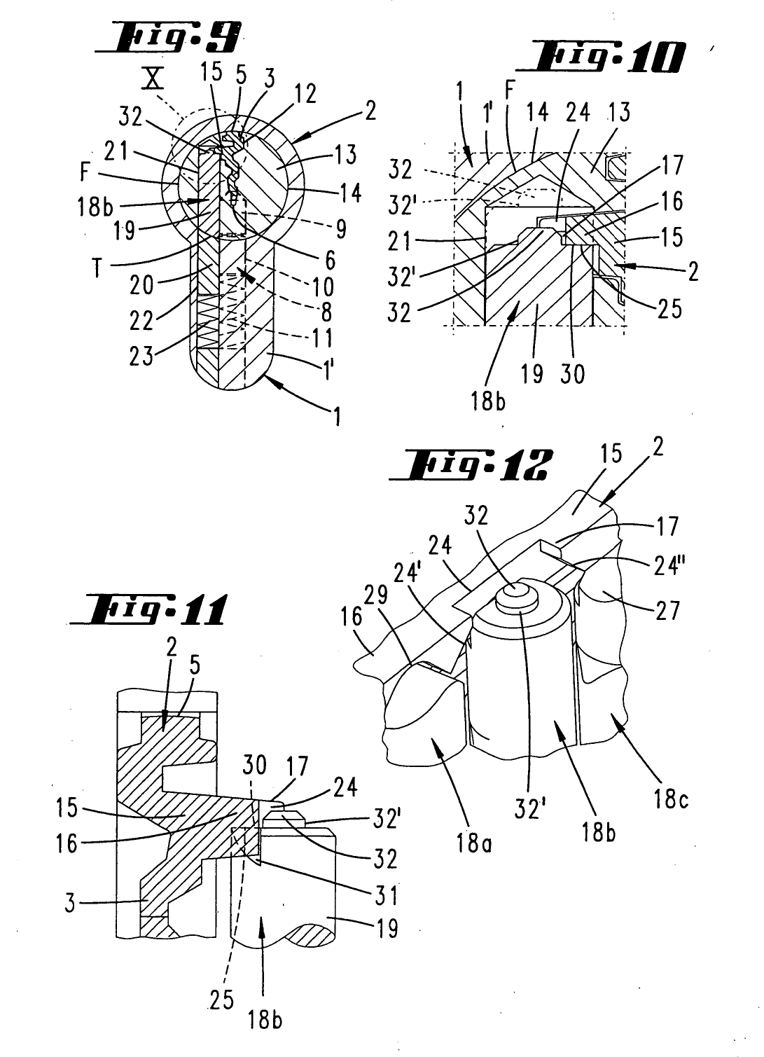

FIG. 10 shows the detail according to X in FIG. 9 greatly enlarged,

FIG. 11 shows the section along the line XI-XI in FIG. 3, greatly enlarged,

FIG. 12 shows in a perspective view the detail according to XII in FIG. 8,

FIG. 13 shows the section along the line XIII-XIII in FIG. 1,

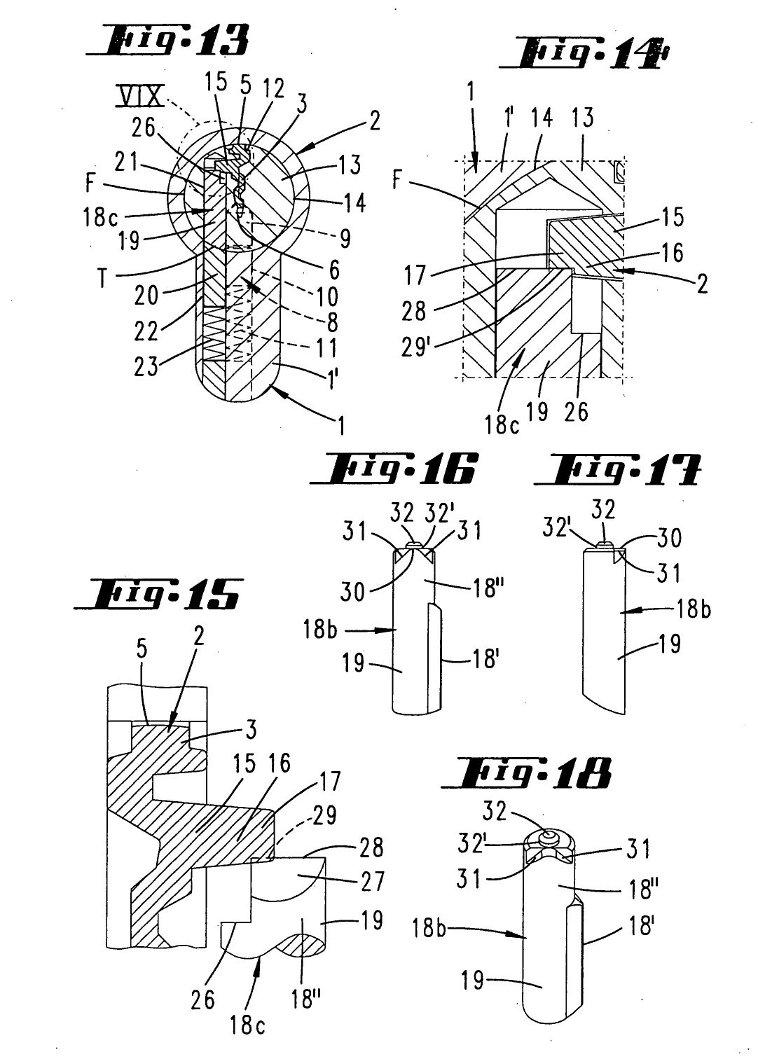

FIG. 14 shows the detail according to XIV in FIG. 13,

FIG. 15 shows the section along the line XV-XV in FIG. 3, greatly enlarged,

FIG. 16 shows an enlarged detailed view of the tumbler pin provided with the tip portion forming the step,

FIG. 17 shows the compressed view of FIG. 16 and

FIG. 18 is a perspective view of this tumbler pin.

Numeral 1 designates a lock cylinder and numeral 2 an associated key. The lock cylinder 1 is a profiled cylinder. A semi-cylinder is illustrated. A double lock cylinder is likewise possible. The key 2 itself is constructed as a flat key. It is composed of a key shank 3 and handling part 4. The key front 6 opposite the key back 5 forms notch-like tumbler wards 7 for aligning a row of tumbler pins 8 extending in the longitudinal centre plane of the lock cylinder 1. The tumbler pins 8 are composed in a known manner from core pins 9 and housing pins 10 and are loaded by pin springs 11 in the direction of a key channel 12 of a cylinder core 13. The cylinder core is arranged in a bearing aperture 14 of the cylinder housing 1′. On insertion of the proper key 2, the tumbler pins 8 are accordingly aligned such that their parting line is located at the level of the rotary joint F of the cylinder core 13. Further details regarding these tumbler pins 8 will not be discussed as they are adequately known in the prior art.

At its one broad side, the key shank 3 has a rib 15 topping it and adjacent to the key back 5. In detail, the rib 15 has a trapezoidal cross-section such that the rib 15 becomes narrower toward its free end. As can be seen in particular from FIG. 3, the tumbler wards 7 extend in front of the rib 15. The rib 15 has two control tracks 16, 17 located side by side in the key insertion direction, which are formed by the lower side of the rib 15. The object of the control tracks 16, 17 is to displace tumbler pins 18 arranged outside of the longitudinal centre plane of the lock cylinder. The tumbler pins are parallel to the broad side plane of the key 2 and therefore also parallel to the longitudinal centre plane of the lock cylinder 1. In the embodiment three such tumbler pins 18 are provided one behind the other. Each tumbler pin 18 is composed of a non-rotatable core pin 19 and a non-rotatable housing pin 20. They are guided in core/housing apertures 21, 22 adapted in cross-section. One of the respective ends of the core apertures 21 end just in front of the rotary joint F of the cylinder core 13 and therefore slightly above the rib 15, as emerges for example from FIG. 5. As a result of this construction, the use of relatively long core pins 19 can be achieved. The tumbler pins 18 are pressurised by pin springs 23. When the key 2 is not inserted into the key channel 12, the upper ends of the core pins 19 are accordingly supported on the upper end of the core openings 21. This means that the parting line T between the core pins 19 and the housing pins 20 is located within the cylinder core 13 and accordingly leads to rotary blocking thereof.

It can be seen in particular from FIG. 2 that the tumbler pins 18 scanning the rib 15 have a drop-shaped cross-section, of which the drop tips 18′ are located on the longitudinal centre plane x-x of the row of tumbler pins 18. Only the sections 18″ of the core pins 19 of the tumbler pins 18 forming the tips and cooperating with the control tracks 16, 17 are circular in cross-section.

The central tumbler pins 8 and the decentral tumbler pins 18 are staggered in the key insertion direction and, in particular, arranged so as to overlap one another. The apertures receiving the tumbler pins 8, 18 are thus prevented from penetrating one another.

As FIG. 3 shows in particular, a respective approach bevel 16′, 17′ is associated with each control track 16, 17. The control bevels 17′ of the control track outside the ribs 17 is a greater distance from the key tip S. The control track outside the ribs 17 also has an interruption point 24. This is in the form of a recess. The recess is longer than the tumbler pin diameter. The recess 24 is flanked by bevels 24′, 24″ forming a roof shape with one another. A notch indentation 25 of the inner control track 16 ends in the recess 24, cf. in particular FIG. 10.

For the purpose of better distinction, the tumbler pins 18 are designated by the letters a, b and c. The tip 18″ of the tumbler pin 18a scanning the control track outside the ribs 17 has a recess 26 associated with the control track inside the ribs 16. In detail, the tip 18″ has control bevels 27 forming a roof shape with one another and with a control ridge 28. While the control bevels 27 cause axial displacement of the tumbler pin 18a, the control ridge 28, in cooperation with the control track 17, fixes the position of the tumbler pin 18a when the key is inserted. The parting line T between core pin 19 and housing pin 20 is then at the level of the rotary joint F. The recess 26 of the tumbler pin 18a is of such a size that movement of the tumbler 18a is not hindered. The control bevels 27 forming a roof shape with one another enclose an angle corresponding to the notch 29 of the control track 17.

While the control ridge 28 of the tumbler pin 18a scans the outer control track 17, the control ridge 30 of the tumbler pin 18b cooperates with the control track inside the ribs 16. The control bevels 31 converging there in the control ridge 30 cooperate with the notch indentation 25. The control ridge 30 is topped by a tip portion 32 associated with the control track outside the ribs 17. The tip portion 32 is a stepped offset peg which forms a step 32′. If the recess 24, for example, is missing on the rib-outer lying track 17, the tip portion 32 of the tumbler pin 18b lacks freedom to yield. This tumbler pin 18b is therefore not properly aligned and blocks rotational displacement of the cylinder core 13.

Only the proper key 2, which forms the two control tacks 16, 17 and the mutually offset approach bevels 16′, 17′, can be fully inserted into the key channel 12. This is accompanied by control of all tumbler pins, so the parting lines T thereof are located in the rotary joint F of the cylinder core 13. During the insertion or removal movement, the bevels 24′, 24″ associated with the interruption point 24 cooperate with the tips of the tumbler pins 18. The lock cylinder 1 can accordingly be locked by means of the key 2 after it has been inserted. The proper alignment positions can be seen in particular from FIG. 5, 9 and 13.

When using an unauthorised key which, for example, only has the inner control track 16, the tumbler pins 18a and 18c are not released and remain in their blocking position. This means that the parting lines T of these tumbler pins 18a and 18c are not located on the rotary joint F. It should be emphasised with respect to the tumbler pin 18c that it corresponds in its construction to the tumbler pin 18a. Only the control track 17 has a notch 29′ of less depth at the corresponding tip.

Keys which do not form properly configured control tracks, as has been mentioned above, do not properly align the tumbler pins and accordingly cause a locking block.

The mutual offsetting of the approach bevels 16′, 17′ is also necessary. If they are congruent, even insertion of the key will be blocked. Owing to the approach bevel 16′ located closer to the key tip S there is namely, in cooperation with the facing control bevel 31′ of the tumbler pin 18b, a displacement thereof, so the circumferential surface of the tip portion 32 of the tumbler pin 18b cannot act in an insertion-impeding manner.

All disclosed features are essential (individually) to the invention. The disclosure of the associated/accompanying priority documents (copy of the prior application) is also hereby included in its entirety in the disclosure of the application, also for the purpose of taking up features of these documents into the claims of the present application.

1. Lock cylinder (1) with a suitable key (2), the lock cylinder (1) comprising a cylinder core (13) rotatably mounted in the cylinder housing (1′) and having a key channel (12) for entry of the key (2), which key (2) has a height-profiled rib (15) topping its broad side, of which the tumbler wards (25, 29, 29′) cooperate with the tips of tumbler pins (18) arranged in a row and consisting of non-rotatable core pins and housing pins in such a way that the tumbler pins (18) guided in the core/housing apertures crossing the rotary joint (F) between cylinder core (13) and cylinder housing (1′) are aligned in terms of height such that the parting line (T) between core and housing pins (19, 20) aligns with the rotary joint (F), characterised in that the rib (15) comprises a plurality of control tracks (16, 17) extending side by side in the key insertion direction, which as a consequence of an adapted tumbler pin tip configuration are selectively scanned by individual tumbler pins (18).

2. Lock cylinder according to claim 1, characterised in that the tip of a tumbler pin (18a, 18c) scanning the one control track (17), in particular the control track outside the ribs, comprises a recess (26) associated with the other control track (16), in particular the control track inside the ribs.

3. Lock cylinder according to any one or more of the preceding claims, characterised in that the tip of a tumbler pin (18) comprises a control bevel (27 or 31) associated with the control track (16 or 17) scanned thereby.

4. Lock cylinder according to any one or more of the preceding claims, characterised in that the control ridge (30) of a tumbler pin (18b) scanning the control track inside the ribs (16) is topped by a tip portion (32) associated with the control track outside the ribs (17), with which portion a recess (24) of the control track outside the ribs (17) is associated.

5. Lock cylinder according to any one or more of the preceding claims, characterised in that the tip section (32) located next to the control bevel (31) associated with the control track inside the ribs (16) does not form a control bevel but, in particular, a step (321).

6. Lock cylinder according to any one or more of the preceding claims, characterized in that the recess (24) is longer than the tumbler pin diameter.

7. Lock cylinder according to any one or more of the preceding claims, characterised by a further row of tumbler pins (8) which scan notch-like wards (7) of the key front (6) and are staggered in the key insertion direction and, in particular, are located so as to overlap with the tumbler pins (18) scanning the rib (15).

8. Lock cylinder according to any one or more of the preceding claims, characterised in that the tumbler pins (18) scanning the rib (15) have a drop-shaped cross-section with drop tips (18′) located on the longitudinal centre plane (x-x) of the row of tumbler pins (18).

9. Lock cylinder according to any one or more of the preceding claims, characterised in that the portion (18′) of the tumbler pin (18) forming the tip is circular in cross-section.

10. Flat key (2) for a lock cylinder (1) according to any one or more of the preceding claims, comprising a height-profiled rib (15) topping its broad side, characterised in that the rib (15) comprises at least two control tracks (16, 17) located side by side in the key insertion direction, which can be scanned by tumbler pins (18) of the lock cylinder (1) arranged parallel to one another and displaceable parallel to the broad side plane.

11. Flat key according to claim 10, characterised in that the rib (15) is adjacent to the key back (5).

12. Flat key according to any one or more of the preceding claims or, characterised in that tumbler wards (7) associated with the key front (6) are located in front of the rib (15).

13. Flat key according to any one or more of the preceding claims, characterised in that the control track outside the ribs (17) comprises at least one interruption point (24).

14. Flat key according to any one or more of the preceding claims, characterised in that the rib (15) comprises two approach bevels (16′, 17′) offset in the key insertion direction, which are each associated with a control track (16 or 17).

15. Flat key according to any one or more of the preceding claims, characterised in that the approach bevel (17′) outside the ribs is more remote from the key tip (S) than the other approach bevel.
